(19) United States
(12) Patent Application Publication
(10) Pub. No.: US 2009/0060249 A1
(43) Pub. Date: Mar. 5, 2009

(54) FLEXIBLE SPEAKER

(75) Inventors: Chang-Ho Liou, Changhua County (TW); Ming-Daw Chen, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/960,735

(22) Filed: Dec. 20, 2007

(30) Foreign Application Priority Data
Sep. 5, 2007 (TW) 96133046

(51) Int. Cl. H04R 25/00; H04R 1/02

(52) U.S. Cl. 381/386; 381/182

(57) ABSTRACT

A flexible speaker including a retractor, a flexible speaker panel, and at least one support element is provided. The flexible speaker panel is connected to the retractor, and is capable of being rolled up and received in the retractor. The support element, capable of memorizing shape, is disposed on the flexible speaker. The support element is used for being rolled up and received in the retractor, together with the flexible speaker. When the flexible speaker panel is spread from the retractor, the support element supports the flexible speaker and keeps the flexible speaker panel being steady in a spread state, and the size of the spread region is determined by the user.

### CROSS-REFERENCE TO RELATED APPLICATION

This application claims the priority benefit of Taiwan application serial no. 96133046, filed on Sep. 5, 2007. The entirety of the above-mentioned patent application is hereby incorporated by reference herein and made a part of this specification.

### BACKGROUND OF THE INVENTION

1. Field of the Invention

The present invention relates to a speaker. More particularly, the present invention relates to a speaker with a flexible structure.

2. Description of Related Art

As the rapid development of the technology relevant to flexible electronics, for example, displays used on computers have gradually developed from early cathode ray tube (CRT) displays to current liquid crystal displays (LCDs), which will be further developed towards flexible flat panel displays adopting flexible substrates in the future. The flexible displays have relatively significant flexible features in terms of shape and size, so it has similar technical developing trend on other devices. Audio is one of the important elements in the flexible electronics, so the research and development of the flexible speaker is one of the critical issues, and the flexible speaker must have the characteristics of being soft, thin, and flexible as the flexible electronics. Therefore, how to make a break through in the conventional speaker with an upright configuration has become one of the key points in developing the flexible electronics.

### SUMMARY OF THE INVENTION

The present invention is directed to a speaker with a flexible structure, for enhancing the convenience in usage.

The present invention provides a speaker with a flexible structure, in which the speaker includes a retractor, a flexible speaker panel, and at least one support element. The flexible speaker panel is connected to the retractor, and capable of being received in the retractor. The support element is capable of memorizing the shape and is disposed on the flexible speaker panel. The support element is used for being rolled up and received in the retractor together with the flexible speaker panel. When the flexible speaker panel is spread from the retractor, the support element supports the flexible speaker panel, for keeping the whole or a part of the flexible speaker panel being steady in a spread state.

The present invention provides a flexible speaker having a function of being rolled up and received, which includes a retractor and a flexible speaker panel. The retractor has a set of vertical brackets, for vertically spreading the flexible speaker, and further includes another set of base-support brackets, for fixing the retractor at any position.

In order to make the aforementioned and other objects, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a flexible speaker and a flexible speaker panel in a spread state according to a first embodiment of the present invention.

FIG. 2 is a schematic view of the flexible speaker and the flexible speaker panel of FIG. 1 in a roll-up state.

FIG. 3 is a cross-sectional side view of the flexible speaker and the retractor of FIG. 1.

FIG. 4 is a cross-sectional view of the flexible speaker panel and the support element of FIG. 1.

FIG. 5 is a cross-sectional view of a flexible speaker panel and a support element of a flexible speaker according to a second embodiment of the present invention.

FIG. 6 is a cross-sectional view of a flexible speaker panel and a support element of a flexible speaker according to a third embodiment of the present invention.

FIG. 7 is a cross-sectional view of a flexible speaker panel and a support element of a flexible speaker according to a fourth embodiment of the present invention.

FIG. 8 is a cross-sectional view of a flexible speaker panel and a support element of a flexible speaker according to a fifth embodiment of the present invention.

FIG. 9 is a cross-sectional view of a flexible speaker panel and a support element of a flexible speaker according to a sixth embodiment of the present invention.

FIG. 10A is a schematic view of a flexible speaker and a flexible speaker panel in a spread state according to another embodiment of the present invention.

FIG. 10B is a schematic view of the flexible speaker panel of FIG. 10A in the roll-up state.

FIG. 10C is a back view of the flexible speaker and the retractor of FIG. 10A.

FIG. 10D is a cross-sectional view of the flexible speaker panel and the support element of FIG. 10A.

### DESCRIPTION OF EMBODIMENTS

The present invention provides a speaker, which is capable of reducing the storage space, and enhancing the convenience in usage.

The flexible speaker provided by the present invention has functions of being rolled up and received, and has a simple structure, and the flexible speaker can be fabricated with the current technology, which is suitable for mass production. Therefore, the products produced through utilizing the roll-up design for the flexible speaker provided by the present invention will be one of the important parts in the flexible electronics technology. The flexible speaker provided by the present invention includes a retractor, a flexible speaker panel, a braking element, and at least one support element. The flexible speaker panel is connected to the retractor and is received in the retractor. The support element is capable of memorizing the shape and is disposed on the flexible speaker panel. The support element is used for being rolled up and received in the retractor together with the flexible speaker. When the flexible speaker is spread from the retractor, it is fixed by the braking element, and the support element has a supporting force, which is capable of supporting the flexible speaker panel, for keeping the whole or a part of the flexible speaker panel being in a spread state.

The flexible speaker of the present invention having functions of being rolled-up and received includes a retractor and a flexible speaker panel. The retractor includes a set of vertical brackets, for vertically spreading the flexible speaker, and further includes another set of base-support brackets, for fixing the retractor at any position.

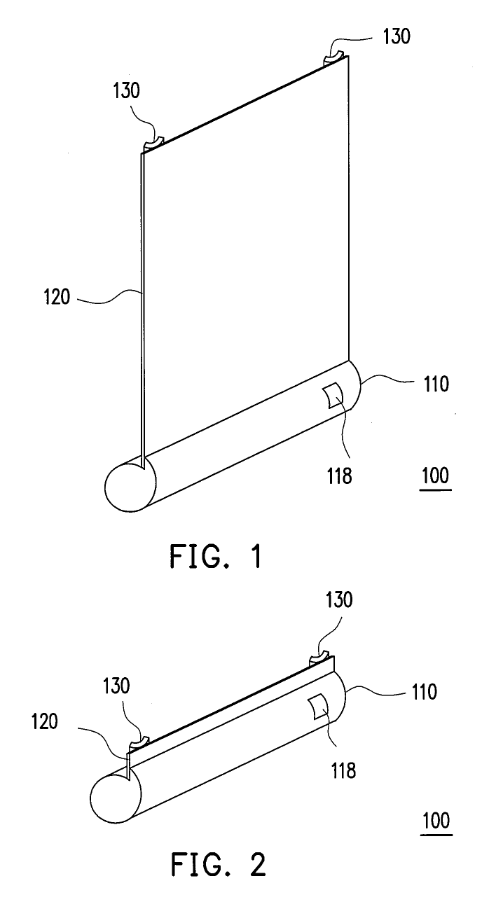

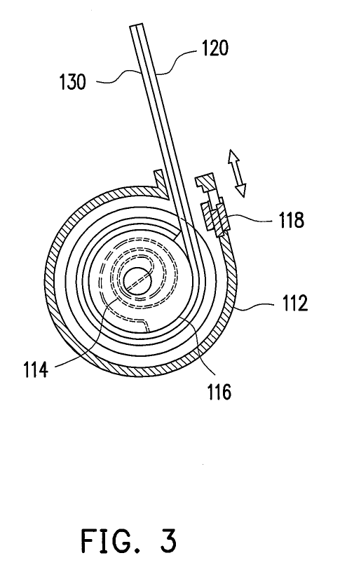

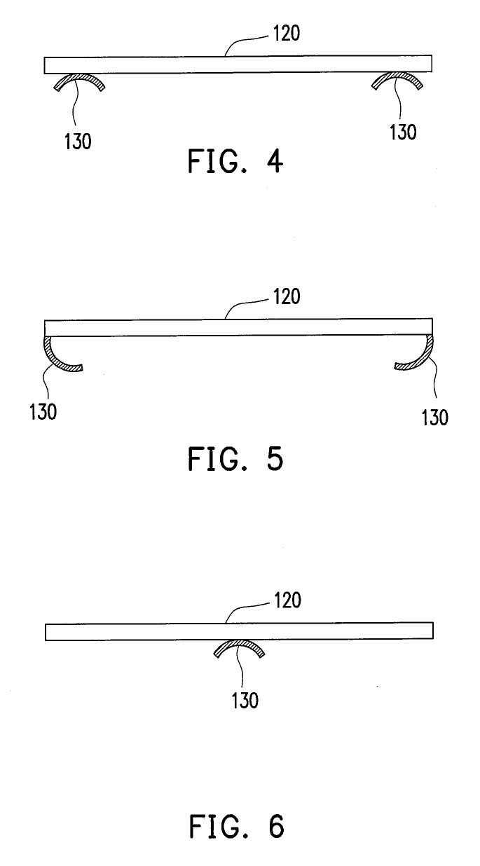

Herein, as for the flexible speaker provided by the present invention, a specific embodiment is used for illustration. Referring to FIGS. 1 to 4, FIG. 1 is a schematic perspective view of a flexible speaker in a spread state. FIG. 2 is a schematic perspective view of the flexible speaker panel of FIG. 1 in a roll-up state. FIG. 3 is a cross-sectional side view of the flexible speaker and the retractor of FIG. 1. FIG. 4 is a cross-sectional view of the flexible speaker panel and the support element of FIG. 1. A flexible speaker 100 in a first embodiment includes a retractor 110, a flexible speaker panel 120, and two support elements 130. The retractor 110 includes a case 112 and a roller 116. One side edge of the flexible speaker panel 120 is connected to the roller 116, and the flexible speaker panel 120 can be rolled up onto the roller 116 in advance, and can be received in the case 112. When the flexible speaker 100 is used, the user can manually spread the flexible speaker 100 from the retractor 110 or make the whole or a part of the flexible speaker panel 120 be received in the retractor 110. The case 112 can be rectangle-shaped or triangle-shaped, and it is capable of keeping the flexible speaker 100 in an upright state during spread.

The retractor 110 includes an energy-storage element disposed within the roller 116. Once the flexible speaker panel 120 is drawn out of and spread from the retractor 110, the energy-storage element accumulates the energy. Therefore, when it intends to draw back the flexible speaker panel 120, under the situation that no external forces are applied thereon, the energy-storage element releases the accumulated energy to make the flexible speaker panel 120 be automatically received back into the case 112. In another embodiment, the energy-storage element can also be replaced by a device requiring a power supply, for finishing the rolling up and receiving operations, for example a micro-motor. Through the disposition of the energy-storage, element, the retractor 110 can draw back the flexible speaker panel 120 through a manual or a fully automatic mode.

In an embodiment, the energy-storage element can be an elastomer or a spring, and the spring is taken as an example for illustration in this embodiment. As shown in FIG. 3, the spring 114 is disposed on the roller 116 in the case 112 of FIG. 2. Therefore, when the user manually spreads the flexible speaker panel 120 from the retractor 110, the spring 114 firstly accumulates an elastic potential energy, such that when no forces are applied on the flexible speaker panel 120 by the user, the spring 114 releases the accumulated elastic potential energy to drive the roller 116 to roll up and to receive the flexible speaker panel 120 back to the case 112.

In the first embodiment, the flexible speaker panel 120 can only utilize the elastic potential energy accumulated by the spring 114 in the retractor 110 to achieve the function of being automatically rolled up and received into the case 112, and when the user wants to spread the flexible speaker panel 120, he/she still has to draw out the flexible speaker panel 120 manually. As described above, the rolling-up and receiving manner of the retractor 110 is not limited to the spring 114 in the first embodiment, but the retractor 110 can include an automatic controlling mechanism, which is capable of automatically spreading or rolling-up the flexible speaker panel 120.

The retractor 110 further includes a braking element 118 disposed on the case 112, for determining whether the flexible speaker panel 120 is rolled up and received back to the roller 116 or it is drawn out from the roller 116. Therefore, once the flexible speaker panel 120 is drawn out and spread from the retractor 110, the braking element 118 can fix the flexible speaker panel 120 to be maintained in the spread state.

The braking element 118 can fix the flexible speaker panel 120 at a suitable position of the roller 116 through utilizing the friction force applied on the surface of the flexible speaker panel 120. In an alternative embodiment, the braking element 118 can fix the flexible speaker panel 120 at a suitable position of the roller 116 through a buckling manner.

The support elements 130 are capable of memorizing the shape. When the flexible speaker panel 120 is rolled up and received in the retractor 110, the support elements can be rolled up and received in the retractor 110 together with the flexible speaker panel 120. When the flexible speaker panel 120 is spread from the retractor 110, the support elements 130 recover their original shape, for example, an elongated arc strap shape, under the situation that no external forces are applied thereon. Therefore, the flexible speaker panel 120 is supported through utilizing the tension of the support elements 130 themselves, so as to assist the flexible speaker to resist the gravity during the spreading process, and thus preventing the flexible speaker from being bent. In an embodiment, the support elements 130 can be support straps located on both sides of the back side of the flexible speaker panel 120 respectively, and the original cross section is arc-shaped. In other embodiments that are not shown, the support elements can be of other varied shapes, for example, U-shaped or V-shaped support straps.

In another alternative embodiment, the support elements 130 can be vertical brackets disposed on the case 112 by folding or another manner, which are used for vertically spreading the flexible speaker panel 120.

A flexible speaker according to a second specific embodiment of the present invention is shown in FIG. 5, in which the support elements 130 in the elongated arc strap-shaped configuration are connected to two side edges of the flexible speaker panel 120 with one of the two ends of the support elements 130.

A flexible speaker according to a third specific embodiment of the present invention is shown in FIG. 6, in which the support element 130 in the elongated arc strap-shaped configuration is separately located at the central region of the back side of the flexible speaker panel 120.

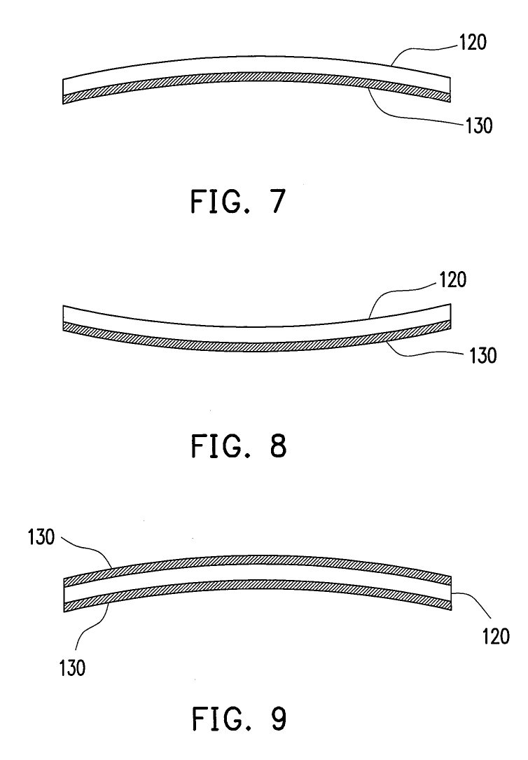

A flexible speaker according to a fourth specific embodiment of the present invention is shown in FIG. 7, in which the support element 130 is a support layer with an up-concave arc-shaped original cross section. The support layer is disposed on the surface of the flexible speaker panel 120, which is used for being rolled up and spread together with the flexible speaker panel 120, and supporting the flexible speaker panel 120. Since the support element 130 must be rolled up and spread together with the flexible speaker panel 120, when selecting the material, both the elasticity and the feature of being capable of supporting the whole flexible speaker panel 120 must be considered. In the alternative embodiment, the support element 130 can be made of an electroactive polymer (EAP), i.e., a plastic capable of generating actions once a voltage is applied on both ends thereof and suitable current flows there through, which is currently called a new type man-made muscle. Once an electric field is applied, a dielectric elastomer (e.g., silica gel or acrylic material, etc.) may be shrunk along the direction of the electric field, and may be expanded along a vertical direction, which is called Maxwell stress in physics. The construction of the support element 130 is substantially similar to that of a rubber capacitor with a dielectric material sandwiched between two parallel boards having electric charges. Once the power source is turned on, positive and negative electric charges are accumulated on opposite electrodes, and they attract each other, such that the polymeric insulator is compressed and deformed, and the material is even hardened, thereby supporting the whole flexible speaker panel 120. However, once the power source is turned off, the support element 130 recovers the original elastic and plastic features, which is suitable for rolling up and spreading.

A flexible speaker according to a fifth specific embodiment of the present invention is shown in FIG. 8, in which the support element 130 is a support layer with a recessed arc-shaped original cross-section. The support layer is disposed on the bottom surface or on the surface of the flexible speaker panel 120. In order to prevent the speaker from being affected by the layer-shaped support element 130, the support element 130 further can be a porous material or a reticular structure. Since the support element 130 must be rolled up and spread together with the flexible speaker panel 120, when selecting the material, both the elasticity and the feature of being capable of supporting the whole flexible speaker panel 120 must be considered. In an alternative embodiment, the material of the support element 130 can be obtained with reference to the embodiment of FIG. 7.

A flexible speaker according to a sixth specific embodiment of the present invention is shown in FIG. 9, in which the support element 130 is formed by a plurality of support layers disposed on the surface of the flexible speaker panel 120. In order to prevent the speaker from being affected by the layer-shaped support element 130, the support element 130 can further be a porous material or a reticular structure.

Since the support element 130 must be rolled up and spread together with the flexible speaker panel 120, when selecting the material, both the elasticity and the feature of being capable of supporting the whole flexible speaker panel 120 must be considered. In the alternative embodiment, the material of the support element 130 can be obtained with reference to the embodiment of FIG. 7.

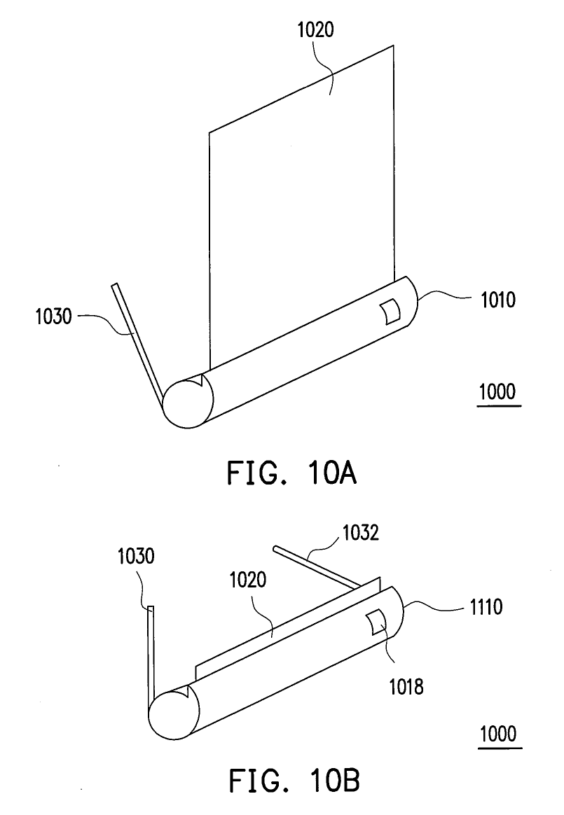

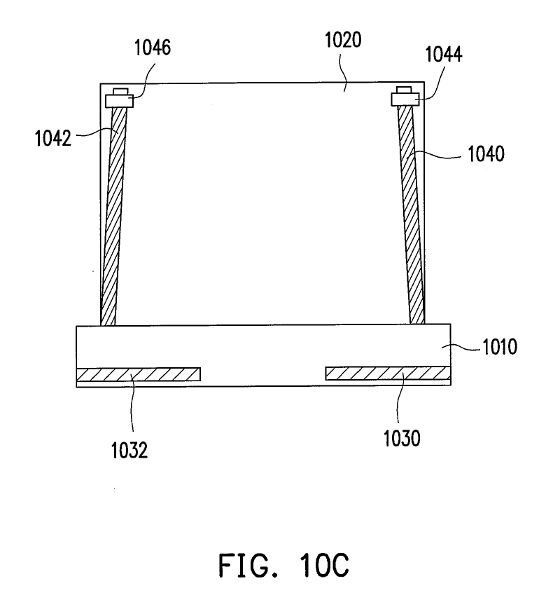

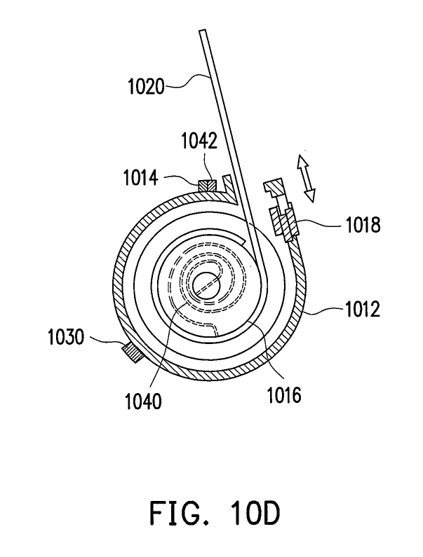

In another specific embodiment, the present invention provides a flexible speaker with the function of being rolled up and received. Referring to FIGS. 10A to 10D, FIG. 10A is a schematic perspective view of a flexible speaker in the spread state, FIG. 10B is a schematic perspective view of the flexible speaker of FIG. 10A in the rolled-up state, FIG. 10C is a perspective back view of the flexible speaker in the spread state, and FIG. 10D is a cross-sectional view of the flexible speaker panel and the support element of FIG. 10A.

In this embodiment, the flexible speaker 1000 includes a retractor 1010, a flexible speaker panel 1020, and a set of vertical brackets 1040 and 1042, for vertically spreading and fixing the flexible speaker panel 1020.

The retractor 1010 includes a case 1012 and a roller 1016, in which one side edge of the flexible speaker panel 1020 is connected to the roller 1016, and the flexible speaker panel 1020 can be rolled up on the roller 1016 in advance and can be received in the case 1012. When the flexible speaker 1000 is used, the user can manually spread the flexible speaker panel 1020 from the retractor 1010 or make the whole or a part of the flexible speaker panel 1020 be received in the retractor 1010.

The retractor 1010 includes an energy-storage element 1014 disposed in the roller 1016. When the flexible speaker panel 1020 is drawn out and spread from the retractor 1010, the energy-storage element 1014 can accumulate the energy. Therefore, when it intends to draw back the flexible speaker panel 1020, under the situation that no external forces are applied thereon, the energy-storage element 1014 releases the accumulated energy to make the flexible speaker panel 1020 be automatically rolled up and received into the case 1012. The energy-storage element 1014 is, for example, a spring. In another embodiment, the energy-storage element 1014 can also be replaced by a device requiring a power supply, for finishing the retraction operation, for example, a micro-motor. Through the disposition of the energy-storage element, the retractor 1010 can draw back the flexible speaker panel 1020 through a manual or fully automatic mode.

The case 1012 can be rectangle-shaped or triangle-shaped, which is capable of keeping the flexible speaker 1000 being in an upright state during spread.

The case 1012 can be barrel-shaped, and at this time, the flexible speaker 1000 further includes a set of base-support brackets 1030 and 1032, for fixing the retractor 1010 to be placed on a plane or at any position to avoid tilting.

If the vertical brackets 1040 and 1042 are not used, they can be received on the retractor 1010. When the flexible speaker panel 1020 is spread, the vertical brackets 1040 and 1042 are drawn out for being respectively fixed on fixing units 1044 and 1046 on the back of the flexible speaker panel 1020. The fixing units 1044 and 1046 are fixed through using, for example, a fixing clamp, a Velcro, or a magnet. In addition, a set of base-support brackets 1030 and 1032 are installed under the two bases of the retractor 1010. When the flexible speaker panel 1020 is spread, the retractor 1010 can be fixed to be stably placed on the plane or at any position to avoid tiling.

To sum up, the user uses the spread flexible speaker to listen to sounds, and when the user does not use it, the support element can make the flexible speaker panel be rolled up and received in the retractor, so the flexible speaker reduces the occupied space and increases the portable convenience, which presents tremendous advantages on the industrial design in the future.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A flexible speaker, comprising:
a retractor;
a flexible speaker panel, connected to the retractor, and capable of being rolled up and received in the retractor; and
at least one support element, having a characteristic of memorizing shapes, disposed on the flexible speaker panel, and capable of being rolled up and received in the retractor together with the flexible speaker panel, wherein when the flexible speaker panel is spread from the retractor, the support element supports the flexible speaker panel, for keeping the flexible speaker panel being steady in the spread state.

2. The flexible speaker as claimed in claim 1, wherein the retractor has a case and a roller.

3. The flexible speaker as claimed in claim 2, wherein the case is designed into a rectangle-shaped or triangle-shaped configuration, for keeping the flexible speaker being in an upright state during spread.

4. The flexible speaker as claimed in claim 1, wherein the retractor is one of a manual retractor or an automatic retractor.

5. The flexible speaker as claimed in claim 1, wherein the retractor comprises an energy-storage element disposed in the roller of the case; when the flexible speaker is spread, the energy-storage element accumulates an energy, such that if no force is applied to the flexible speaker panel, the energy accumulated by the energy-storage element is used to drive the roller to make the flexible speaker panel be rolled up and received into the case.

6. The flexible speaker as claimed in claim 5, wherein the energy-storage element is an elastomer.

7. The flexible speaker as claimed in claim 5, wherein the energy-storage element is a spring.

8. The flexible speaker as claimed in claim 1, wherein the retractor comprises an automatic controlling mechanism, capable of driving the roller to automatically spread or roll up the flexible speaker panel.

9. The flexible speaker as claimed in claim 1, wherein a braking element is placed in the retractor and disposed on the case, for fixing the flexible speaker panel to be in a spread state or a roll-up state.

10. The flexible speaker as claimed in claim 9, wherein the braking element fixes the flexible speaker panel through using a friction force applied on the flexible speaker panel.

11. The flexible speaker as claimed in claim 9, wherein the braking element comprises a buckling element for fixing the flexible speaker panel.

12. The flexible speaker as claimed in claim 1, wherein the support element is a support strap, disposed on a surface of the flexible speaker.

13. The flexible speaker as claimed in claim 1, wherein the support element has one of an arc-shaped, U-shaped, or V-shaped cross section.

14. The flexible speaker as claimed in claim 1, wherein the support element is a support layer, disposed on a surface of the flexible panel.

15. The flexible speaker as claimed in claim 14, wherein the support element has an arc-shaped cross section.

16. The flexible speaker as claimed in claim 14, wherein when being disposed on the surface of the flexible speaker panel, the layer-shaped support element is a porous material or a reticular structure.

17. The flexible speaker as claimed in claim 1, wherein the support element further comprises a plurality of support layers, disposed on the surface of the flexible panel.

18. The flexible speaker as claimed in claim 17, wherein the support element has an arc-shaped cross section.

19. The flexible speaker as claimed in claim 17, wherein when being disposed on a display surface of the flexible speaker panel, the layer-shaped support element is a porous material or a reticular structure.

20. The flexible speaker as claimed in claim 17, wherein the layer-shaped support element comprises electroactive polymer (EAP); once a voltage is applied, the layer-shaped support element is deformed and the used material is hardened enough for supporting the flexible speaker panel.

21. The flexible speaker as claimed in claim 17, wherein the layer-shaped support element comprises two layers of electrodes and a layer of EAP sandwiched there-between; once a voltage is applied on the two electrodes, the layer-shaped support element is deformed and the used material is hardened enough for supporting the flexible speaker panel.

22. A flexible speaker, comprising:
a retractor;
a flexible speaker panel, connected to the retractor, and rolled up and received in the retractor; and
at least one set of vertical brackets, disposed above the retractor; wherein when the flexible speaker panel is drawn and spread from the retractor, the set of vertical brackets is elastically fixed on the flexible speaker panel, for keeping the flexible speaker panel being steady in the spread state.

23. The flexible speaker as claimed in claim 22, wherein the retractor has a case and a roller.

24. The flexible speaker as claimed in claim 23, wherein the case is designed into a rectangle-shaped or triangle-shaped configuration, for keeping the flexible speaker being in an upright state during spread.

25. The flexible speaker as claimed in claim 23, wherein a braking element is placed into the retractor and disposed on the case, for fixing the flexible speaker panel to be in a spread state or a roll-up state.

26. The flexible speaker as claimed in claim 23, wherein when the case has a barrel-shaped configuration, the flexible speaker further comprises a set of base-support brackets, capable of being spread and fixing the retractor to avoid tilting.
